(19) United States
(12) Patent Application Publication
(10) Pub. No.: US 2025/0292670 A1
(43) Pub. Date: Sep. 18, 2025

(54) REMOTE MONITORING SYSTEM AND METHOD FOR CONTROLLED POPULATION

(71) Applicant: Endur ID, Inc., Hampton, NH (US)

(72) Inventor: Albert Larose, Dracut, MA (US)

(21) Appl. No.: 19/081,066

(22) Filed: Mar. 17, 2025

Related U.S. Application Data
(60) Provisional application No. 63/566,633, filed on Mar. 18, 2024.
(60) Provisional application No. 63/575,279, filed on Apr. 5, 2024.

(51) Int. Cl. G08B 25/01; G08B 25/10; H04B 1/3827; H04W 4/021

(52) U.S. Cl. CPC G08B 25/016; G08B 25/10; H04B 1/385; H04W 4/021

(57) ABSTRACT

Provided is a population tracking system including a wireless tracking device including a flexible band and a clasp, a mobile device including at least one processor and an application executable by the at least one processor to wirelessly communicate with the wireless tracking device, a monitoring system including at least one processor and configured to receive information from the mobile device and interpret the information from the mobile device, and a monitor device comprising at least one processor and an application executable by the at least one processor configured to communicate with the monitoring system. The monitoring system is configured to generate and provide at least one of location information, alerts and alarms to at least one of the mobile device and the monitor device.

### RELATED APPLICATIONS

This application claims the benefit of U.S. Provisional Application No. 63/566,633, filed Mar. 18, 2024, U.S. Provisional Application No. 63/575,279, filed Apr. 5, 2024 and U.S. Provisional Application No. 63/747,277, filed Jan. 20, 2025, the contents of which are incorporated herein by reference in their entireties.

The present application may be related to U.S. application Ser. No. 18/584,206, filed Feb. 22, 2024, which claimed priority to U.S. Provisional Application No. 63/447,439, filed Feb. 22, 2023, and U.S. Provisional Application No. 63/458,995, filed Apr. 13, 2023, the contents of each of which are incorporated herein by reference in their entireties.

The present application may be related to U.S. application Ser. No. 16/867,673, filed May 6, 2020, now U.S. Pat. No. 11,308,748, which claimed priority to U.S. Provisional Application No. 62/848,131, filed May 15, 2019, the contents of each of which are incorporated herein by reference in their entireties.

The present application may be related to U.S. application Ser. No. 16/678,690, filed Nov. 8, 2019, now U.S. Pat. No. 11,297,906, which claimed priority to U.S. Provisional Application No. 62/757,778 filed Nov. 9, 2018 and U.S. Provisional Application No. 62/841,405 filed May 1, 2019, the contents of each of which are incorporated herein by reference in their entireties.

The present application may be related to U.S. Design application No. 29/849,631, filed Aug. 12, 2022, the contents of each of which are incorporated herein by reference in their entireties.

The present application may be related to U.S. application Ser. No. 15/497,849, filed Apr. 26, 2017, now U.S. Pat. No. 10,441,037, which was a continuation in part application that claimed priority to U.S. application Ser. No. 15/097,556, filed Apr. 13, 2016, now U.S. Pat. No. 10,188,176, which was a continuation of U.S. application Ser. No. 13/656,206, filed Oct. 19, 2012, now U.S. Pat. No. 9,339,408, which claimed priority to U.S. Provisional Application No. 61/550,152, filed Oct. 21, 2011, the contents of each of which are incorporated herein by reference in their entireties.

### FIELD

The inventive concepts relate to systems and methods useful for monitoring and/or tracking a controlled population, e.g., patients, inmates, parolees, and the like.

### BACKGROUND

Parolees are tracked using a variety of technologies. Parolees may be tracked by a GPS or a combination GPS/Wifi/LTE. The GPS trackers are worn by parolees and transmit their location to a monitoring station.

The current GPS trackers drain a battery of the GPS quickly and require frequent recharging while being worn. The battery life of current GPS trackers is measured in hours.

In addition, the current GPS trackers are very large and cumbersome making the GPS trackers difficult to wear and hide. The current GPS trackers are difficult for laborers to wear on job sites and have limited resistance to abusive environments on job sites. Further, as the GPS trackers are difficult to hide, the parolees are unable to disguise the GPS trackers, for example, during job interviews.

### SUMMARY

In accordance with aspects of the inventive concepts, provided is a population tracking system, including a wireless tracking device, comprising a flexible band securable to a user and a clasp configured to irremovably secure overlapping portions of the flexible band and the processor. The flexible band includes a transmission medium extending along at least a portion of its length; a processor coupled to the transmission medium; and a wireless communication device coupled to the processor. The system further comprises a mobile device comprising at least one processor and an application executable by the at least one processor to wirelessly communicate with the wireless tracking device, a monitoring system comprising at least one processor and configured to receive information from the mobile device and interpret the information from the mobile device, and a monitor device comprising at least one processor and configured to communicate with the monitoring system. The monitoring system is configured to generate and provide at least one of location information, alerts and alarms to at least one of the mobile device and the monitor device. The monitoring system is configured to generate and provide an alarm to at least one of the mobile device and the monitor device in response to the mobile device travelling out of communication range of the wireless tracking device.

In some embodiments, the flexible band further comprises a memory comprising detection logic executable by the processor of the flexible band to transmit a cut detection signal via the wireless communication device of the flexible band in response to a lack of continuity in the transmission medium.

In some embodiments, the mobile device is configured to wirelessly communicate the cut detection signal to the monitoring system and the monitoring system is configured to generate and provide an alarm to at least one of the mobile device and the monitor device in response to the cut detection signal.

In some embodiments, a cut or break in the transmission medium is processed by the processor of the wireless tracking device as the lack of continuity in the transmission medium.

In some embodiments, signal degradation over the transmission medium is processed by the processor of the wireless tracking data as the lack of continuity in the transmission medium.

In some embodiments, the wireless tracking device comprises a Bluetooth communication device secured to or integral with the clasp.

In some embodiments, the transmission medium is a conductive medium or a fiber optic medium.

In some embodiments, the transmission medium is an inlay antenna.

In some embodiments, the processor, the inlay antenna, and the wireless communication device comprise a RFID (Radio Frequency Identification) device.

In some embodiments, the inlay antenna is a Near Field Communication (NFC) inlay antenna.

In some embodiments, the inlay antenna extends at least 90 percent of the length of the flexible band.

In some embodiments, the information received by the monitoring system from the mobile device comprises at least one of location information, a cut band detection signal, battery information of the wireless tracking device, and battery information of the mobile device.

In some embodiments, the monitoring system is further configured to generate and provide an alarm to at least one of the mobile device and the monitor device in response to the wireless tracking device travelling outside a designated zone.

In some embodiments, the monitoring system is further configured to generate and provide an alarm to at least one of the mobile device and the monitor device in response to the wireless tracking device travelling within a forbidden zone.

In some embodiments, the monitoring system is further configured to generate and provide an alarm to at least one of the mobile device and the monitor device in response to the wireless tracking device travelling within a predetermined distance of another designated mobile device.

In some embodiments, the monitoring system is further configured to generate and provide an alarm to at least one of the mobile device and the monitor device in response to the wireless tracking device not being within the specific geo-fences during specific times.

In some embodiments, the monitoring system is further configured to generate and provide an alarm to at least one of the mobile device and the monitor device in response to a low battery of the wireless tracking device and/or the mobile device.

In some embodiments, the monitoring system is further configured to generate and provide a schedule to at least one of the mobile device and the monitor device including permissions, obligations, and/or curfews.

In some embodiments, the mobile device comprises a mobile phone.

In some embodiments, the monitor device comprises at least one of a mobile phone, tablet, laptop and a PC.

In some embodiments, the monitoring system comprises a cloud-based server or dashboard.

In accordance with aspects of the inventive concepts, provided is a population tracking system, including a wireless tracking device, comprising a flexible band securable to a user and a clasp configured to irremovably secure overlapping portions of the flexible band and the processor. The flexible band includes a transmission medium extending along at least a portion of its length; a processor coupled to the transmission medium; and a wireless communication device coupled to the processor. The system further comprises a first mobile device comprising at least one processor and an application executable by the at least one processor to wirelessly communicate with the wireless tracking device, a monitoring system comprising at least one processor and configured to receive information from the mobile device and interpret the information from the mobile device, a monitor device comprising at least one processor and configured to communicate with the monitoring system, and a second mobile device comprising at least one processor and an application executable by the at least one processor to wirelessly communicate with the monitoring system. The monitoring system is configured to generate and provide at least one of location information, alerts and alarms to at least one of the mobile device and the monitor device. The monitoring system is configured to generate and provide an alarm to at least one of the first mobile device, the monitor device and the second mobile device in response to the wireless tracking device travelling within a predetermined distance of the second mobile device.

In various embodiments, the flexible band further comprises a memory comprising detection logic executable by the processor of the flexible band to transmit a cut detection signal via the wireless communication device of the flexible band in response to a lack of continuity in the transmission medium.

In various embodiments, the first mobile device is configured to wirelessly communicate the cut detection signal to the monitoring system and the monitoring system is configured to generate and provide an alarm to at least one of the first mobile device and the monitor device in response to the cut detection signal.

In various embodiments, the wireless tracking device comprises a Bluetooth communication device secured to or integral with the clasp.

In various embodiments, the information received by the monitoring system from the mobile device comprises at least one of location information, a cut band detection signal, battery information of the wireless tracking device, and battery information of the mobile device.

In various embodiments, the monitoring system is further configured to generate and provide an alarm to at least one of the first mobile device and the monitor device in response to the wireless tracking device travelling outside a designated zone.

In various embodiments, the monitoring system is further configured to generate and provide an alarm to at least one of the first mobile device and the monitor device in response to the wireless tracking device travelling within a designated zone.

In various embodiments, the monitoring system is further configured to generate and provide an alarm to at least one of the first mobile device and the monitor device in response to the wireless tracking device not being within the specific geo-fences during specific times.

In various embodiments, the monitoring system is further configured to generate and provide an alarm to at least one of the first mobile device and the monitor device in response to a low battery of the wireless tracking device and/or the mobile device.

In various embodiments, the monitoring system is further configured to generate and provide a schedule to at least one of the first mobile device and the monitor device including permissions, obligations, and/or curfews.

In various embodiments, the first mobile device and the second mobile device comprise a mobile phone.

In various embodiments, the monitor device comprises at least one of a mobile phone, tablet, laptop and a PC.

In various embodiments, the monitoring system comprises a cloud-based server or dashboard.

In various embodiments, when the wireless tracking device travels within a predetermined distance of the second mobile device, the monitoring system is configured to generate and provide location information of the wireless tracking device to the second mobile device.

### BRIEF DESCRIPTION OF THE DRAWINGS

The foregoing and other features and advantages of embodiments of the present inventive concept will be apparent from the more particular description of embodiments of the inventive concept, as illustrated in the accompanying drawings in which like reference characters refer to the same elements throughout the different views. The drawings are not necessarily to scale, emphasis instead being placed upon illustrating the principles of the inventive concept in the drawings.

FIG. 1 illustrates an embodiment of a clasp including Bluetooth communications capability, according to an example embodiment of the inventive concepts.

FIG. 2 illustrates an embodiment of components of the clasp of FIG. 1, according to an example embodiment of the inventive concepts.

FIG. 3 is an illustrative front exploded view of a clasp, and related components, according to an example embodiment of the inventive concepts.

FIG. 4 is an illustrative perspective exploded view of a clasp, and related components according to an example embodiment of the inventive concepts.

FIG. 5 is an illustrative perspective cutaway view of a clasp, and certain components of the clasp, including a light pipe, flexible band, and radio transmitter module, according to an example embodiment of the inventive concepts.

FIG. 6 is an illustrative perspective view of a clasp, having a light pipe and flexible band disposed therein, according to an example embodiment of the inventive concepts.

FIG. 7 illustrates an embodiment of a band including a Near Field Communication (NFC) wet inlay antenna, according to aspects of the inventive concepts.

FIG. 8 illustrates an embodiment of a population tracking system, according to aspects of the inventive concepts.

FIG. 9 illustrates an embodiment of a population tracking system, according to aspects of the inventive concepts.

FIG. 10 illustrates an example of a schedule that can be created by a mobile device application.

### DETAILED DESCRIPTION

Various aspects of the inventive concepts will be described more fully hereinafter with reference to the accompanying drawings, in which some exemplary embodiments are shown. The drawings are not necessarily to scale, emphasis instead being placed upon illustrating the principles of the inventive concept in the drawings. The present inventive concepts may, however, be embodied in many different forms and should not be construed as limited to the exemplary embodiments set forth herein.

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

Provided is a population tracking and/or monitoring system and method used to monitor one or more monitored persons. In various embodiments, the monitoring and/or tracking is personal to a specifically identified individual. In various embodiments, one or more systems, including at least one processor coupled to at least one data storage device (collectively “Monitoring System”) may be configured to wirelessly communicate with a plurality of personal wireless tracking devices, such as the BlueTrac device provided by Endur ID of New Hampshire. In various embodiments, the communication between the Monitoring System and the personal wireless tracking device can occur via a mobile phone app (operating on mobile phone or other personal, portable device with wireless communication capability) that communicates with a personal wireless tracking device. The communication link between components of the system can include GPS, cellular, LTE, Bluetooth, WiFi, and any of a variety of other now-known or later developed wireless communications devices, technologies, and/or systems.

In various embodiments, the systems and methods can be applied in the context of parolee and detainee officer arrangement, as one example. In other embodiments, the systems and method can be applied with other populations.

In various embodiments, the systems and methods can generate alerts based on status of the personal wireless tracking device, such as if the band is cut or otherwise compromised (cut detection), the Bluetooth device is damaged or otherwise compromised, or a battery of the device is low. Alarms and/or alerts can be generated in response to other circumstances, e.g., the personal wireless tracking device has travelled outside a communication range of the mobile phone app, designated zone or within a forbidden zone (e.g., using geofencing), or the monitored person misses a curfew or an appointment. Various rights, permissions, obligations, and/or curfews of a parolee (or other monitored person) can be tied to a schedule forming part of the mobile phone app.

The wireless tracking device according to the present inventive concepts is smaller and less cumbersome than current GPS trackers and provides a longer battery life. In various embodiments, a parolee wears a wireless tracking device including a flexible band and a clasp for enclosing and protecting a portion of the flexible band. The wireless tracking device is water resistant, durable, small, ankle or wrist wearable, and concealable. In various embodiments, a battery disposed in the clasp has a two-year battery life; however, the present inventive concepts are not limited thereto. The band and clasp are irremovable without tampering. The band and clasp include a cut detection system to indicate if the band has been cut or tampered with. The wireless tracking device includes a radio including a wireless BLE (BlueTooth) communication to a mobile device and NFC (Near Field Communication) with the band. The radio provides continuous communication with a mobile phone of the parolee. The clasp provides a secure housing for the radio for durability and provides a secure means for attaching the radio to the band. The wireless tracking device can communicate to any assigned mobile device up to 25 feet away; however, the inventive concepts are not limited thereto.

As used herein, the terms “band,” “flexible band,” and “flexible strip” may refer to any of the various flexible materials or substrates disclosed herein, or other flexible materials not specifically mentioned herein, used or useful for forming an identification band. In various forms, the flexible band is a printable band or one of a plurality of bands in a sheet of printable bands. A secure band is a flexible band that is intended to be irremovable by the individual wearing the band, e.g., on a wrist or ankle.

The clasp can be provided for enclosing and protecting at least a portion of a flexible band and, in an example embodiment, for securing and/or encasing the connecting or overlapping portions of one or more bands. A “clasp,” as used herein, comprises a rigid body having one or more parts that encase a portion of the band. Some example embodiments provide a clasp having mechanically interlocking members that, when interlocked together, encase and surround a portion of a band, e.g., the connected ends (or a seam) or overlapped portions of a band. The clasp may be configured to prevent slippage of the band within the clasp and protect an enclosed seam or overlapped portion, for example, from being disconnected by external factors, such as manipulation by a wearer of the band. The clasp and flexible band are configured to be irremovable without tampering by the individual wearing the flexible band.

The wireless tracking device can be used with a parolee, registered sex offender, monitored individual, individuals having a certain status or condition, or others.

The flexible bands may include Valdron® Strength Films, which is a flexible cross laminated high strength polyethylene film. The cross laminated high strength polyethylene film may be treated with polyester on both sides to protect the strap from heat. A coating on the cross laminated high strength polyethylene film may be water proof and scratch proof in order to protect the information stored on the strap.

The clasp is very difficult or substantially impossible to open without tools or breakage, and is not able to be used as a weapon. It is also, preferably, comfortable and unobtrusive when worn.

The clasp described herein may be used to bind any two flat ribbon or band like materials without any destruction of the bound materials. For example, the clasp described herein may bind two ribbons containing fiber optics without destroying the integrity of the optics within.

In various embodiments, the clasp may be a clasp as described in connection with U.S. Pat. No. 11,308,748, the contents of which are incorporated herein by reference. For example, in various embodiments, the clasp of the present invention includes two identical or substantially identical interlocking members that connect to secure and enclose a portion or portions of a band. In such cases, any two interlocking members can be used to form a clasp, such that the user need not be concerned with getting two different parts. For example, a package of 100 interlocking members would yield 50 clasps, no matter which two interlocking members were taken from the bag, in an exemplary embodiment.

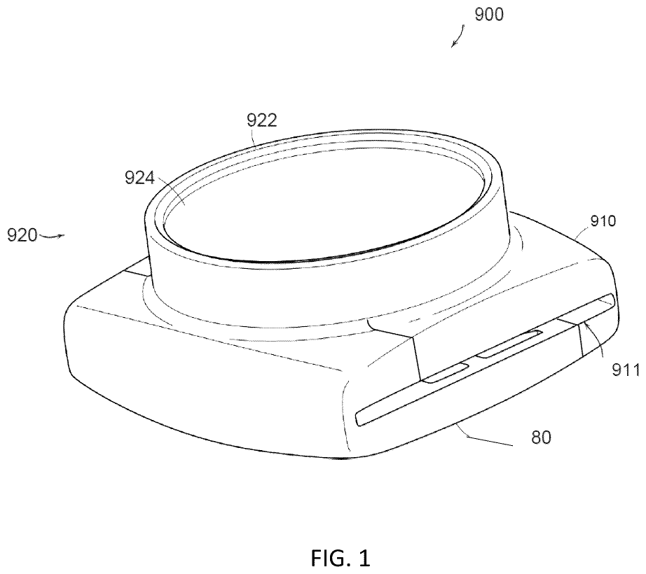

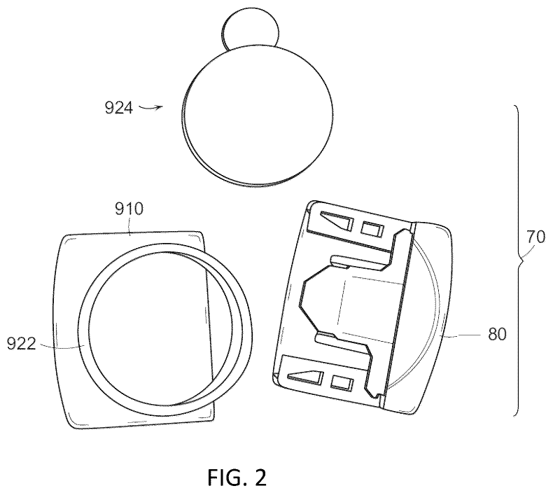

FIG. 1 shows an embodiment of a clasp 900 including Bluetooth communications capability. FIG. 2 shows an embodiment of components of the clasp of FIG. 1.

The clasp 900 includes first interlocking member 80 and a second interlocking members 910. Interlocking member 910 can be substantially the same as interlocking member 80 with respect to various features and structures for securing together the interlocking members with a band secured therein that passes through a channel 911 formed within the clasp 900. Preferably, interlocking member 910 has at least one hook and at least one recess, where each recess is configured to receive a hook from another interlocking member and has a wall configured to prevent external access to the hook received within the recess, such as interlocking member 80.

In this embodiment, the clasp 900 includes a Bluetooth communication device 920. In various embodiments, the Bluetooth communication device 920 can be integral with, embedded within, or coupled to an outer shell 912 of the interlocking member 910. In various embodiments, the Bluetooth device 920 can be adhered to the outer shell 912 of the interlocking member 910. In various embodiments, the Bluetooth communication device 920 can be a sticker beacon 924 having a round shape and includes a 1 piece CR2016 coin battery. In various embodiments the beacon 924 can be maintained by a holder 922 secured to or integral with the outer shell 912.

In various embodiments, the Bluetooth communication device 910 can take the form of or include a Beacon, iBeacon, or miniBeacon, such as i9 Pilot MiniBeacon by Minew Technologies.

In various embodiments, the clasp may be a clasp as described in connection with U.S. Provisional Application No. 63/747,277.

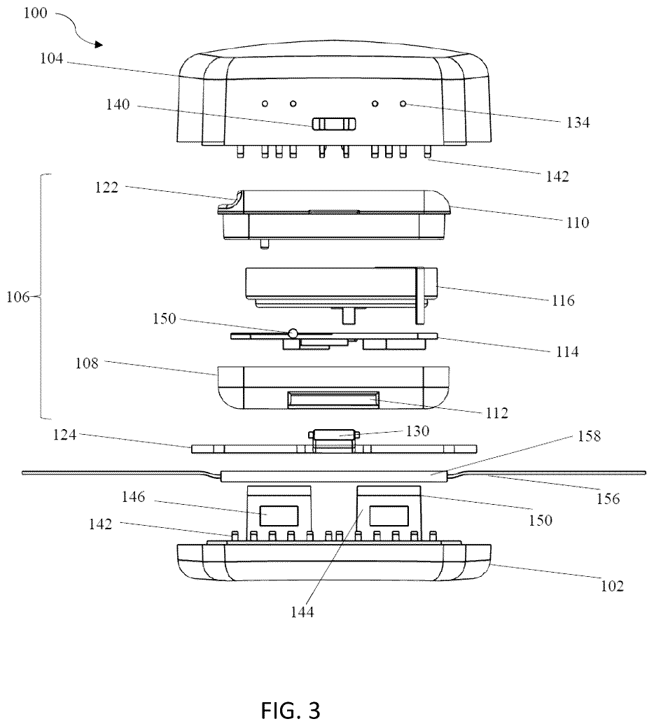

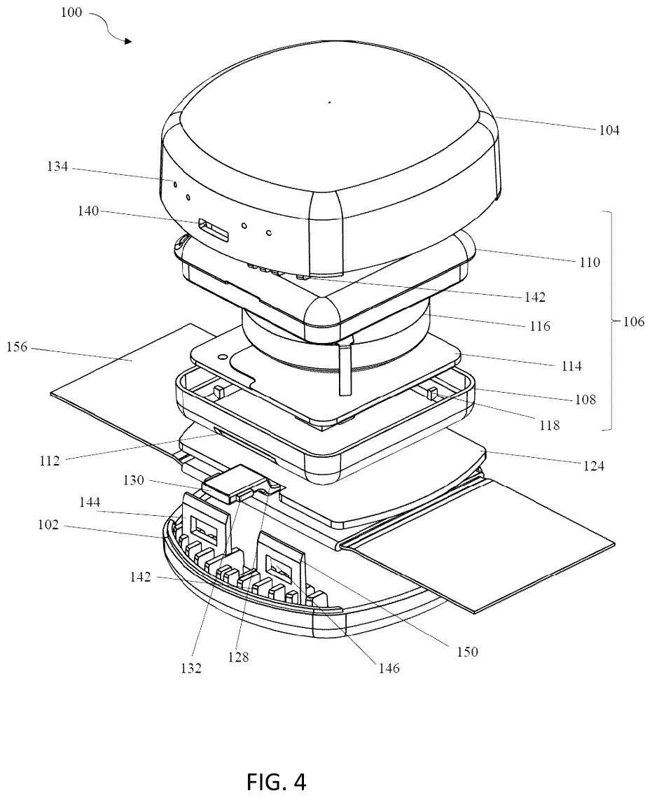

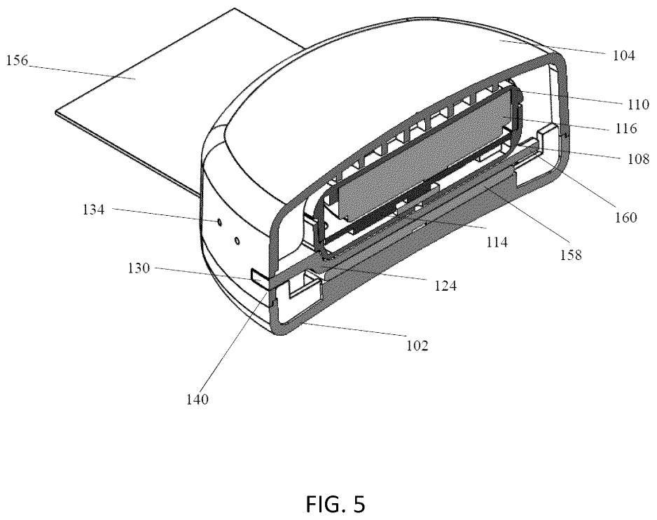

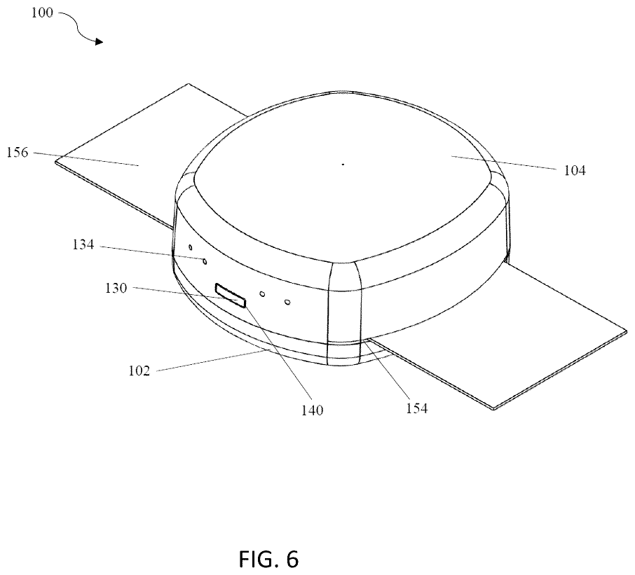

FIGS. 3 and 4 show a first interlocking member 102 and a second interlocking member 104 that combine to form a clasp 100 within which a flexible band (or “band”) 156 may be secured, see also FIGS. 5 and 6. In the embodiments depicted, the first and second interlocking members 102, 104 of the clasp 100 are of different geometries or shapes. In some embodiments, the first and second interlocking members 102, 104 can be of the same geometry or shape so that they are interchangeable. In various embodiments, the clasp 100 may be dimensioned to accommodate available 1″ bands. In other embodiments the clasp may be dimensioned to fit ¾″ and ½″ bands, as examples. There are no inherent limitations on the scaling or uses of the clasp and bands.

A band 156, for example, a strap or wrist band, may be waterproof, chemical resistant, and scratchproof. In addition, the band 156 may be stretch proof and tear proof so that removal requires a mechanical cutting by other than human force, for example, by a tool. The band 156 may include at least one of a strip of cables, plastic, and fibers, as examples.

In some embodiments, the first and second interlocking members 102, 104 of the clasp 100 are constructed and arranged to enclose and prevent access to a portion of the band 156 including adhesive flaps 158. The adhesive flaps 158 serve to operate as a closure region where two portions, of at least one band overlap. Further in the cutaway side perspective view of FIG. 5, for example, the first interlocking member 102 and the second interlocking member 104 are depicted with a band 156 positioned between the two interlocking members 102, 104 at the location corresponding to the overlapping position where the adhesive flaps 158 are overlapping the band 156.

In some embodiments, the first interlocking member 102 of the clasp 100 includes a planar surface 148 that interacts with the overlapping flaps 158 of the band 156 in an adhesion region of the band. The first interlocking member 102 also includes at least one snap feature 144 that extends transversely from a upper surface of the first interlocking member 102 to engage a corresponding interlocking hook 138 of the second interlocking member 104.

In some embodiments, the at least one snap feature 144 includes an angled top portion 150 and a recess 146, that allow the at least one snap feature to slidably interlock with the interlocking hook 138 of the second interlocking member 104. In some embodiments, multiple snap features 144 are distributed about the perimeter of the first and second interlocking members 102, 104; in this manner they substantially simultaneously engage to lock different spaced-apart portions of the first and second interlocking members 102, 104.

In some embodiments, the second interlocking member 104 of the clasp 100 includes at least one aperture 134. The at least one aperture is configured to be depressed by a disassembly tool 152 to separate the first interlocking member 102 from the second interlocking member 104. The second interlocking member 104 also includes a light pipe opening 140, to allow for the surface output 130 of the light pipe 124 to be visible when the clasp 100 is in a locked state.

In some embodiments, both the first and second interlocking members 102, 104 include the use of ribs 142 in their design. In some embodiments, the ribs 142 add structural rigidity to the clasp 100, as well as serve to align the first interlocking member 102 with the second interlocking member 104 when the clasp 100 is attempting to be locked.

In some embodiments, the clasp 100 comprises a light pipe 124. In some embodiments, the light pipe 124 includes a plate 126, a heel 128, a light transmitting portion 130, a locating feature 132, and a rear guide. The plate 126 extends along a first horizontal axis and the light transmitting portion 130 extends along a second horizontal axis. The first horizontal and the second horizontal axis lie on different vertical planes.

In some embodiments, the rear guide of the light pipe 124 rests in a receiving channel 162 of the first interlocking member 102 to locate the light pipe 124 at the proper orientation and location. Further, the second interlocking member 104 includes a light pipe retainer 136 to secure the light pipe 124 to the second interlocking member 104 when the first and second interlocking members 102, 104 of the clasp 100 are in a locked configuration.

In some embodiments, as illustrated in FIGS. 3-4, the clasp 100 further includes a radio transmitter module 106. In some embodiments, the radio transmitter module 106 comprises a first shell member 108 and a second shell member 110 that house a power source, a printed circuit board (PCB) 114, and an optical indicator. The power source in some embodiments may comprise a battery 116. In some embodiments, the first shell member 108 includes an indentation 112 that accommodates, or otherwise conforms to a shape of the heel 128 of the light pipe 124. When the heel 128 is lined up with the indentation 112, the optical indicator of the PCB 114 is positioned to display optical energy at a visible wavelength to the surface output 130 of the clasp 100.

The radio transmitter module 106 further includes a wireless BLE device and NFC device.

In some embodiments, the second shell member 110 of the radio transmitter module 106 includes a concave top portion 122 at least one side. This concave top portion 122 aligns with the ribs 142 of the second interlocking member 104 at an extended rib portion 166 that aligns with the radio transmitter module 106 of the second interlocking member 104.

In some embodiments, the first shell member 108 includes at least one standoff 118. The standoff 118 serves to elevate the PCB 114 relative to the base of the first shell member 108. In doing so, this ensures that if the clasp 100 is physically or mechanically manipulated, either intentionally, or unintentionally, that the electronics contained within the radio transmitter module 106 will remain unaffected by the applied external stresses.

In some embodiments, the clasp 100 may be constructed of plastic, resin, metal, graphite, ceramics or similar suitable materials. In some embodiments, the clasp may be molded of or generated from a single material that is sufficiently flexible to permit the at least one snap feature 144 to elastically deform into the interlocking hook 138 of the second interlocking member 104, while being strong enough to prevent easy breakage or removal of the clasp 100. In various embodiments, the clasp 100 may be constructed of Acrylonitrile Butadiene Styrene (ABS). Depending on the intended use, a softer plastic with characteristics similar to that of polyolefins, for example, would be avoided with respect to at least the outer protective shell of the clasp, that is, in cases where the clasp functions as a security device.

FIG. 5 is an illustrative perspective cutaway view of a clasp, and certain components of the clasp, including a light pipe, flexible band, and radio transmitter module, according to an example embodiment of the inventive concepts. FIG. 5 provides a view of certain internal components of the clasp 100, and illustrates relative interaction of the components interact with one another at the time the clasp 100 is being worn by a user.

In some embodiments, the radio transmitter module 106 comprises a PCB 114, and a battery 116 contained within a first and second shell member 108, 110. In some embodiments, the first shell member 108 is positioned above the light pipe 124, with the indentation 112 of the first shell member 108 nesting into the heel 128 of the light pipe 124. The nesting of these two elements allow for optimal light transmission from the radio transmitter module 106 through the light transmitting portion 130 to a light pipe opening 140 of the second interlocking member 104.

In some embodiments, the first shell member 108 of the radio transmitter module 106 is securely held in place by the light pipe 124. The light pipe 124 comprises a rear guide 160 which interacts with a retainer element 168 of the second interlocking member 104. The rear guide 160 has an angled top edge allowing for ease of hingedly securing the rear guide 160 of the light pipe 124 to the second interlocking member 104.

In some embodiments, as illustrated in FIGS. 5-6, a portion of the band 156 is positioned at a band channel 154 of the first and second interlocking members 102, 104. As such, the band 156 is positioned along and in contact with the planar surface 148 of the first interlocking member 102, and the underside of the plate 126 of the light pipe 124. In this configuration, the band 156 is arranged in a manner that mitigates or prevents side slip of the band 156 through the band channel 154. This is in part due to the size of the band channel 154 opening and in part due to an adhesion region of the clamp between the adhesive flaps 158 adhering the band 156 to the plate 126 of the light pipe 124 and the planar surface 148 of the first interlocking member 102.

In some embodiments, as further illustrated in FIGS. 5 and 6, a portion of the second interlocking member 104 comprises at least one aperture 134. The at least one aperture 134 of the second interlocking member corresponds to the at least one snap feature 144 of the first interlocking member 102. The at least one aperture 134 is arranged to be partially covered preventing unwanted manipulation of the at least one aperture 134.

In some embodiments, the at least one aperture 134 comprises at least one aperture 134 for each of the at least one snap feature 144.

FIG. 6 is an illustrative perspective view of a clasp, having a light pipe and flexible band disposed therein, according to an example embodiment of the inventive concepts. FIG. 6 provides an assembled view of the clasp 100, and some of the visible elements at the time the clasp 100 is configured to be worn by a user. In particular, the first interlocking member 102 and the second interlocking member are shown in a secured-together state comprising a band 156 passing through a band channel 154.

In some embodiments, the light transmitting portion 130 of the light pipe 124 is visible through the light pipe opening 140 of the second interlocking member 104. The second interlocking member 104 comprises at least one aperture 134 that extends partially through a surface of the second interlocking member 104.

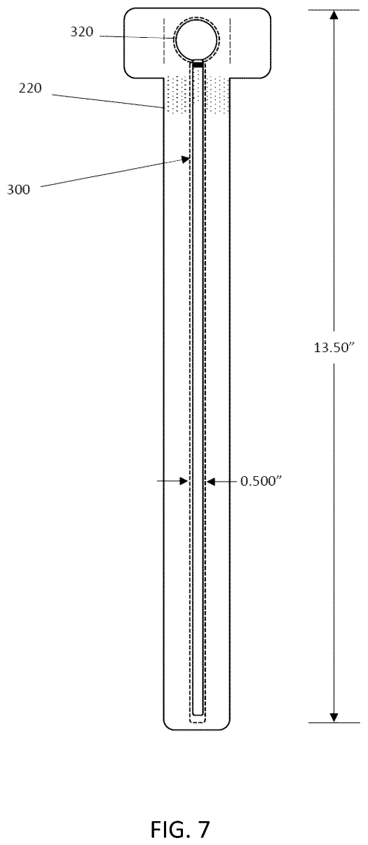

FIG. 7 shows an embodiment of a flexible band including a cut-band (or cut) detection circuit. Referring to FIG. 7, in one embodiment, a flexible band 220 includes a cut-band detection circuit that determines when the flexible band 220 has a lack of continuity, e.g., caused by a cut, break, or other damage to the circuit. The cut detection circuit can send a wireless cut detection signal indicating such determination, referred to as a cut detection signal. For example, a signal degradation over the transmission medium can be processed by a processor of the cut detection circuit as the lack of continuity in the transmission medium. A secure band or secure identification band can include the flexible band and a secure clasp, such as those described herein. The flexible band can include a cut-band detection circuit comprising a memory, a micro-processor, a transmission medium, and a wireless communication device. The flexible band can have at least two states, an intact state and a cut state. The cut state can be indicated as an open circuit or as a short circuit determined by a break (or cut), damage, or occlusion of the transmission medium of the circuit. The transmission medium can be any medium configured to carry a signal e.g., copper or other wires, traces, or strips, or other conductive materials, or optical fiber. In various embodiments, the transmission medium at least 90 percent of the length of the flexible band.

The memory can include computer logic or code that is executable by the processor to generate the cut detection signal in response to the cut, damage, and or occlusion of the transmission medium.

In some embodiments, the cut detection circuit can include a passive RFID inlay attached to the flexible band or forming part of the flexible band. The passive RFID inlay can take the form of or include a Near Field Communication (NFC) inlay antenna 300. In various embodiments, NFC inlay antenna 300 can take the form of or include a Circus™ Tamper Loop.

The band NFC inlay antenna 300 may be adhered to or integral with the flexible band 220 and extend a full or partial length of the band 220. In various embodiments, the inlay antenna extends at least 90 percent of the length of the flexible band. In some embodiments, the inlay antenna can be a wet inlay antenna, e.g., having an adhesive and release liner. In other embodiments, the antenna can be a dry inlay antenna, e.g., without adhesive and release layer.

When the flexible band 220 is cut, broken, or otherwise compromised and the NFC inlay antenna 300 is also cut, broken, or otherwise compromised, the cut detection circuit determines that the band has the cut state. The determination can be due to a lack of continuity in the inlay antenna, which can the indicated by signal degradation over the inlay antenna (transmission medium) caused by a cut, break or other damage to the inlay antenna. The IC 320 in cooperation with the NFC antenna 300 is configured to detect the cut state and generate the cut detection signal, such as an RFID signal. In some embodiments, the IC 320 can have one-time password for protection against cloning.

In some embodiments, the cut detection circuit is configured to communicate with an external or remote device or system when the cut state is detected. That is, the cut detection circuit is configured to communicate with the mobile device (or mobile phone or tablet) of the individual wearing the wireless tracking device. The mobile device is configured for wireless communication, such as being Bluetooth enabled. In such cases, the mobile device can include a mobile device application (or cut detection “app”) executable by a processor of a mobile device to wirelessly communicate with one or more flexible bands to receive the cut detection signal and responsively generate a cut detection indication, which can include an alert.

In some embodiments, the flexible band 220 may be used in connection with a clasp including an RFID device, such as the clasps discussed above. The clasp 900 may be snapped onto the band 220 having the NFC inlay antenna 300 adhered to length of the band to act as cut band detector. The portion of the NFC inlay containing an IC 320 can be placed under or within the clasp to protect the IC.

When the band 220 is cut, broken, or otherwise compromised, the antenna 300 gets physically broken and the break is detected by the IC 320. That is, the state of the NFC inlay antenna 300 can indicate whether or not the band has been broken, cut or otherwise compromised. In response, the IC 320 can generate the cut detection signal for transmission by the RFID device of the cut detection circuit. In some embodiments, the cut detection status of the cut detection circuit can be checked using a mobile device via software, a programmed on-chip URL, or via other forms of applications.

In some embodiments, RF and/or Bluetooth devices in the clasp can provide additional communication technology as an alternative to or to augment the communications of the RFID cut detection circuit. For example, the band having cut detection technology can be used with clasp 900 of FIG. 1 including the Bluetooth communication device 910.

Such communication technology can be used, for example, to locate the band and/or enable communications between the band and mobile device. However, in various embodiments, the band need not include a clasp with RF or Bluetooth communication devices. As an RFID device, the cut detection circuit is capable of transmitting the cut detection signal without the RF or Bluetooth communication devices of the clasp.

The cut detection application can be configured to enable individuals wearing the band to be automatically monitored to ensure that the band 220 has not been damaged, cut and/or removed. The NFC antenna 300 can communicates with the mobile device to indicate that it remains intact (uncut) or that it has been cut according to a schedule. In some embodiments, the mobile device can communicate with or query the band to confirm the band remains in the intact state, e.g., during planned intervals and/or whenever the monitoring mobile device comes within communication range of the band.

The application on the mobile device can process a cut detection signal to generate a cut detection indication, which can include or take the form of an alert at the mobile device, such as an audible and/or visual alert.

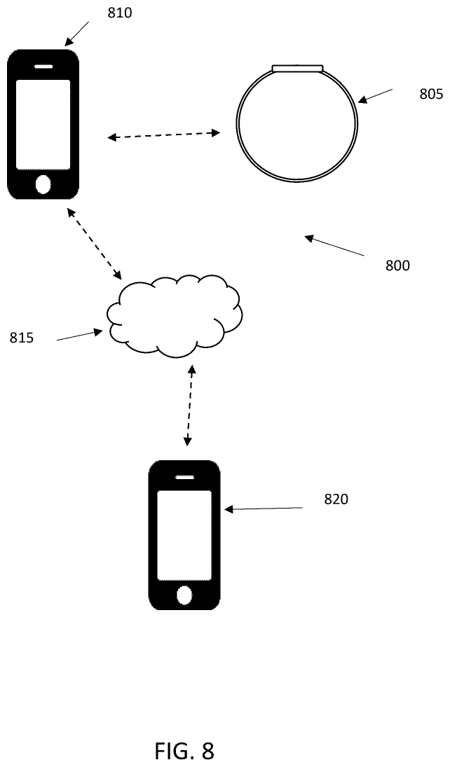

FIG. 8 illustrates the population tracking and monitoring system 800 of the present inventive concepts. In various embodiments, the wireless tracking device 805 is in communication with a mobile device 810 of the individual wearing the wireless tracking device via a mobile phone application (operating on mobile device 810). The mobile device 810 is a wireless communication device, for example, a mobile phone other personal, portable device with wireless communication capability. The mobile device 810 includes at least one processor coupled to at least one data storage device. The mobile device 810 includes an application compatible with Android and iOS. The application can be stored in memory on the mobile device and executed by the processor of the mobile device.

The mobile device 810 communicates with a monitoring system 815. The monitoring system 815 includes, for example, a cloud based server or dashboard. The monitoring system 815 includes at least one processor coupled to at least one data storage device. The monitoring system 815 communicates with the mobile device 810 to enable all alarms, alerts and the GPS location of the mobile device 810 to be communicated to the monitoring system 815 using LTE and/or Wifi.

In various embodiments, the mobile device 810 provides continuous communication with a monitoring system 815. In various embodiments, the mobile device 810 provides continuous communication with the monitoring system while the individual wearing the wireless tracking device 805 is in motion and provides communication at predetermined intervals when the individual wearing the wireless tracking device 805 is stationary. For example, continuous communication is not necessary when the person wearing the wireless tracking device 805 is sleeping.

The monitoring system 815 interprets and communicates information received from the mobile device 810 to monitoring personnel 820. That is, monitoring system 815, interprets the information from the mobile device 810, generates location information, alarms and/or alerts based on the information received from mobile device 810 and provides the location information, alarms and/or alerts to an application on a monitoring personnel's wireless communication device, mobile device, mobile phone, tablet, laptop, PC, or the like. The monitoring personnel's device will be referred to hereinafter as monitor device 820. In some embodiments, the monitor device 820 may include an application compatible with Android and iOS and/or software compatible with laptops and/or workstations. The monitor device 820 includes at least one processor coupled to at least one data storage device. The monitor device 820 receives the location information, alarms/and or alerts in realtime. The monitoring system 815 and monitor device 820 are in communication using LTE and/or Wifi. The population tracking 800 of the present inventive concepts, provides the monitoring personnel continuous access to the parolee's location. The monitoring system may provide the location information to the monitor device 815 as a map. The map may include further information with regard to the location, for example, proximity to designated zones or forbidden zones.

In various embodiments, the monitoring system 815 interprets the information from the mobile device 810, generates location information, alarms and/or alerts based on the information received from mobile device 810 and provides the location information, alarms and/or alerts to the application on the mobile device 810.

The wireless tracking device 805 can only communicate with the mobile device 810 within a certain range based on the communication range of the BlueTooth included in the wireless tracking device 805. If the wireless tracking device 805 goes out of the range of the BlueTooth of the wireless tracking device, an alarm and/or alert is generated by the monitoring system 815 and communicated to the mobile device 810 of the parolee and the monitor device 820.

Alarms and/or alerts can be generated if the wireless tracking device 805 has travelled outside a designated zone. If a parolee is only allowed with certain geo-fences, for example, if the parolee is on house arrest, an alarm and/or alert is generated by the monitoring system 815 and communicated to the mobile device 810 of the parolee and the monitor device 820.

Alarms and/or alerts can be generated if the wireless tracking device 805 has travelled within a forbidden zone. If a parolee is not allowed in certain geo-fences, for example, if the parolee is not allowed within a school zone, an alarm and/or alert is generated by the monitoring system 815 and communicated to the mobile device 810 of the parolee and the monitor device 820.

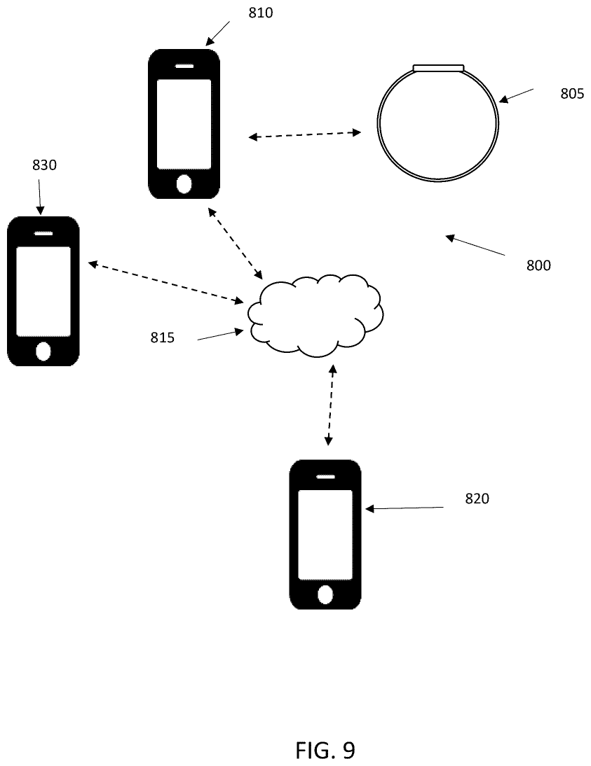

FIG. 9 illustrates an embodiment of a population tracking system, according to aspects of the inventive concepts. Alarms and/or alerts can be generated if the wireless tracking device 805 has travelled within a predetermined distance of another individual. For example, if an individual has a restraining order against the parolee, the parolee is not allowed within a predetermined distance of the individual. In such an embodiment, a mobile device 830 of the individual is also in communication with the monitoring system 815. FIG. 9 includes the population tracking system as described in connection with FIG. 8 and additionally includes a mobile device 830 of the individual. In various embodiments, the mobile device 830 of the individual is in communication with the monitoring system 815 via a mobile phone application (operating on mobile device 830). The mobile device 830 is a wireless communication device, for example, a mobile phone other personal, portable device with wireless communication capability. The mobile device 830 includes at least one processor coupled to at least one data storage device. The mobile device 830 includes an application compatible with Android and iOS. The application can be stored in memory on the mobile device and executed by the processor of the mobile device.

As illustrated in FIG. 9, if the wireless tracking device 805 is within a predetermined distance of the mobile device 830 of the individual, an alarm and/or alert is generated by the monitoring system 815 and communicated to the mobile device 830 of the individual, the mobile device 810 of the parolee and the monitor device 820. In addition, the monitoring system 815 provides location information of the wireless tracking device 805 to the mobile phone application on the mobile device 830 of the individual. The location information of the wireless tracking device 805 provides the individual with the mobile device 830 the ability to determine which direction to go to avoid the individual wearing the mobile tracking device 805.

Alarms and/or alerts can be generated if the wireless tracking device 805 is expected within specific geo-fences during a specific time and the wireless tracking device 805 is not within the specific geo-fences during the specific time. For example, if the monitored person misses a curfew or an appointment, an alarm and/or alert is generated by the monitoring system 815 and communicated to the mobile device 810 of the parolee and/or the monitor device 820.

Alarms and/or alerts can be generated in response to a cut detection signal from the wireless tracking device 805. For example, if the mobile device 810 receives a cut detection signal from the wireless tracking device 805, an alarm and/or alert is generated by the monitoring system 815 and communicated to the mobile device 810 of the parolee and the monitor device 820.

The radio in the clasp communicates with the band using NFC communication. If the radio in the clasp is separated from the band (without cutting the band) and loses communication with the band, for example, if the clasp is tampered with and the radio removed from the clasp, an alarm and/or alert is generated by the monitoring system 815 and communicated to the mobile device 810 of the parolee and the monitor device 820 that the radio is no longer in communication with the band.

Alarms and/or alerts can be generated in response to a low battery of the wireless tracking device 805 and/or the mobile device 810.

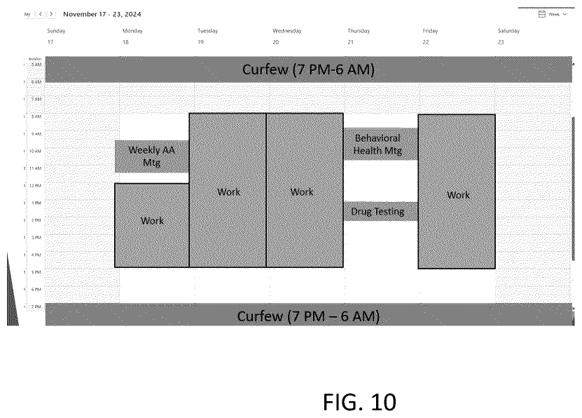

Various rights, permissions, obligations, and/or curfews of a parolee (or other monitored person) can be tied to a schedule forming part of the mobile device application. FIG. 10 illustrates an example of a schedule that can be created by the mobile device application.

Automated check-in alarm creation can be generated, when the individual wearing the wireless tracking device 805 is not where they are required to be in the schedule. For example, when the individual is not at a scheduled meeting, does not make curfew, is not at a court appearance, or is not at work when they are scheduled to be, an alarm and/or alert is generated by the monitoring system 815 and communicated to the mobile device 810 of the parolee and/or the monitor device 820.

Auto reminders can be sent to the mobile device 810 and the monitor device 820 at configurable time intervals prior to appointments.

Report functions can be created for use by the monitor, that is the parolee officers and courts over time documenting all monitoring and alarm conditions for date-to-date intervals and over a life of monitoring and individual.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the invention, which are, for clarity, described in the context of separate embodiments, may also be provide in combination in a single embodiment. Conversely, various features of the invention which are, for brevity, described in the context of a single embodiment may also be provided separately or in any suitable sub-combination.

For example, it will be appreciated that all of the features set out in any of the claims (whether independent or dependent) can combined in any given way.

What is claimed is:

1. A population tracking system, comprising:
a wireless tracking device, comprising:
a flexible band securable to a user, the flexible band comprising:
a transmission medium extending along at least a portion of its length;
a processor coupled to the transmission medium;
a wireless communication device coupled to the processor; and
a clasp configured to irremovably secure overlapping portions of the flexible band and the processor;
a mobile device comprising at least one processor and an application executable by the at least one processor to wirelessly communicate with the wireless tracking device;
a monitoring system comprising at least one processor and configured to receive information from the mobile device and interpret the information from the mobile device; and
a monitor device comprising at least one processor and configured to communicate with the monitoring system;
wherein the monitoring system is configured to generate and provide at least one of location information, alerts and alarms to at least one of the mobile device and the monitor device;
wherein the monitoring system is configured to generate and provide an alarm to at least one of the mobile device and the monitor device in response to the mobile device travelling out of communication range of the wireless tracking device.

2. The system of claim 1, the flexible band further comprising:
a memory comprising detection logic executable by the processor of the flexible band to transmit a cut detection signal via the wireless communication device of the flexible band in response to a lack of continuity in the transmission medium.

3. The system of claim 2, wherein the mobile device is configured to wirelessly communicate the cut detection signal to the monitoring system and the monitoring system is configured to generate and provide an alarm to at least one of the mobile device and the monitor device in response to the cut detection signal.

4. The system of claim 2, wherein a cut or break in the transmission medium is processed by the processor of the wireless tracking device as the lack of continuity in the transmission medium.

5. The system of claim 2, wherein signal degradation over the transmission medium is processed by the processor of the wireless tracking data as the lack of continuity in the transmission medium.

6. The system of claim 1, wherein the wireless tracking device comprises a Bluetooth communication device secured to or integral with the clasp.

7. The system of claim 1, wherein the transmission medium is a conductive medium or a fiber optic medium.

8. The system of claim 1, wherein the transmission medium is an inlay antenna.

9. The system of claim 8, wherein the processor, the inlay antenna, and the wireless communication device comprise a RFID (Radio Frequency Identification) device.

10. The system of claim 8, wherein the inlay antenna is a Near Field Communication (NFC) inlay antenna.

11. The system of claim 8, wherein the inlay antenna extends at least 90 percent of the length of the flexible band.

12. The system of claim 1, wherein the information received by the monitoring system from the mobile device comprises at least one of location information, a cut band detection signal, battery information of the wireless tracking device, and battery information of the mobile device.

13. The system of claim 1, the monitoring system is further configured to generate and provide an alarm to at least one of the mobile device and the monitor device in response to the wireless tracking device travelling outside a designated zone.

14. The system of claim 1, the monitoring system is further configured to generate and provide an alarm to at least one of the mobile device and the monitor device in response to the wireless tracking device travelling within a designated zone.

15. The system of claim 1, the monitoring system is further configured to generate and provide an alarm to at least one of the mobile device and the monitor device in response to the wireless tracking device travelling within a predetermined distance of another designated mobile device.

16. The system of claim 1, the monitoring system is further configured to generate and provide an alarm to at least one of the mobile device and the monitor device in response to the wireless tracking device not being within the specific geo-fences during specific times.

17. The system of claim 1, the monitoring system is further configured to generate and provide an alarm to at least one of the mobile device and the monitor device in response to a low battery of the wireless tracking device and/or the mobile device.

18. The system of claim 1, the monitoring system is further configured to generate and provide a schedule to at least one of the mobile device and the monitor device including permissions, obligations, and/or curfews.

19. The system of claim 1, wherein the mobile device comprises a mobile phone.

20. The system of claim 1, wherein the monitor device comprises at least one of a mobile phone, tablet, laptop and a PC.

21. The system of claim 1, wherein the monitoring system comprises a cloud-based server or dashboard.

22. A population tracking system, comprising:
a wireless tracking device, comprising:
a flexible band securable to a user, the flexible band comprising:
a transmission medium extending along at least a portion of its length;
a processor coupled to the transmission medium;
a wireless communication device coupled to the processor; and
a clasp configured to irremovably secure overlapping portions of the flexible band and the processor;
a first mobile device comprising at least one processor and an application executable by the at least one processor to wirelessly communicate with the wireless tracking device;
a monitoring system comprising at least one processor and configured to receive information from the mobile device and interpret the information from the mobile device; and
a monitor device comprising at least one processor and configured to communicate with the monitoring system;
a second mobile device comprising at least one processor and an application executable by the at least one processor to wirelessly communicate with the monitoring system;
wherein the monitoring system is configured to generate and provide at least one of location information, alerts and alarms to at least one of the first mobile device, the monitor device and the second mobile device;
wherein the monitoring system is configured to generate and provide an alarm to at least one of the first mobile device, the monitor device and the second mobile device in response to the wireless tracking device travelling within a predetermined distance of the second mobile device.

23. The system of claim 22, the flexible band further comprising:
a memory comprising detection logic executable by the processor of the flexible band to transmit a cut detection signal via the wireless communication device of the flexible band in response to a lack of continuity in the transmission medium.

24. The system of claim 23, wherein the first mobile device is configured to wirelessly communicate the cut detection signal to the monitoring system and the monitoring system is configured to generate and provide an alarm to at least one of the first mobile device and the monitor device in response to the cut detection signal.

25. The system of claim 22, wherein the wireless tracking device comprises a Bluetooth communication device secured to or integral with the clasp.

26. The system of claim 22, wherein the information received by the monitoring system from the first mobile device comprises at least one of location information, a cut band detection signal, battery information of the wireless tracking device, and battery information of the mobile device.

27. The system of claim 22, the monitoring system is further configured to generate and provide an alarm to at least one of the first mobile device and the monitor device in response to the wireless tracking device travelling outside a designated zone.

28. The system of claim 22, the monitoring system is further configured to generate and provide an alarm to at least one of the first mobile device and the monitor device in response to the wireless tracking device travelling within a designated zone.

29. The system of claim 22, the monitoring system is further configured to generate and provide an alarm to at least one of the first mobile device and the monitor device in response to the wireless tracking device not being within the specific geo-fences during specific times.

30. The system of claim 22, the monitoring system is further configured to generate and provide an alarm to at least one of the first mobile device and the monitor device in response to a low battery of the wireless tracking device and/or the mobile device.

31. The system of claim 22, the monitoring system is further configured to generate and provide a schedule to at least one of the first mobile device and the monitor device including permissions, obligations, and/or curfews.

32. The system of claim 22, wherein the first mobile device and the second mobile device comprise a mobile phone.

33. The system of claim 22, wherein the monitor device comprises at least one of a mobile phone, tablet, laptop and a PC.

34. The system of claim 22, wherein the monitoring system comprises a cloud-based server or dashboard.

35. The system of claim 22, wherein, when the wireless tracking device travels within a predetermined distance of the second mobile device, the monitoring system is configured to generate and provide location information of the wireless tracking device to the second mobile device.
